(19) United States
(12) Patent Application Publication
(10) Pub. No.: US 2026/0077990 A1
(43) Pub. Date: Mar. 19, 2026

(54) WASHING MACHINE FOR WASHING EMPTY CONTAINERS ADAPTED TO BE FILLED WITH A POURABLE PRODUCT AND RELATIVE METHOD

(71) Applicant: SIDEL PARTICIPATIONS, Octeville-sur-Mer (FR)

(72) Inventor: Andrea SOLFA, Parma (IT)

(21) Appl. No.: 19/106,488

(22) PCT Filed: Aug. 30, 2023
(86) PCT No.: PCT/EP2023/073845

§ 371 Date: Feb. 25, 2025

(30) Foreign Application Priority Data
Aug. 30, 2022 (EP) 22192780.9

(51) Int. Cl. B67C 7/00; B08B 9/30; B08B 9/42; B08B 13/00

(52) U.S. Cl. CPC B67C 7/004; B08B 9/30; B08B 9/423; B08B 13/00; B08B 2209/08; B67C 2007/006

(57) ABSTRACT

Provided is a washing machine for washing empty containers. The machine includes a conveyor having seats for respective containers to convey a plurality of containers in their respective seats along a washing path. The machine includes at least one treatment station including a tank for holding a cleaning medium for washing the containers, the washing path extending through the tank, and at least one ultrasonic wave generator arranged adjacent to the washing path. Also included is a sensor unit for sequentially inspecting each seat for detecting the presence of containers therein downstream of the inlet station, and for generating signals correlated to the absence of containers in the inspected seats. Also included is a control unit configured to receive said signals and to control the ultrasonic wave generator based on the received signals for modulating a level of ultrasonic wave generation.

### TECHNICAL FIELD

The present invention relates to a washing machine for washing (and cleaning) empty containers adapted to be filled with a pourable product, preferably a pourable food product.

The present invention also relates to a method for treating empty containers adapted to be filled with a pourable product, preferably a pourable food product.

### BACKGROUND ART

Washing machines are known which are configured for washing and cleaning containers adapted to be filled with a pourable product (usually used containers which have been emptied from the pourable product they are adapted to contain).

An example of washing machine is known, e.g. from EP-A-2727660 in the name of the same Applicant.

In detail, a typical washing machine is part of a treatment assembly for treating the containers, which treatment assembly comprises also a filling machine, a labelling machine, a capping machine, etc., which machines are distributed successively along a treatment line or path.

Usually, the washing machine is located, along the treatment line, upstream of the filling machine.

A typical washing machine of the above type essentially comprises:
a washing tunnel;
a looped chain conveyor advancing the containers along a closed washing path which extends inside the washing tunnel from an inlet station to an outlet station;
a feeding system for feeding containers to be treated to the chain conveyor; and
a plurality of consecutive treatment zones or stations arranged between the inlet station and the outlet station, crossed by the washing path, and through which the chain conveyor advances the containers.

In detail, the feeding system comprises an endless conveyor and a sequencing device interposed between the endless conveyor and the inlet station of the chain conveyor.

The endless conveyor defines a moving platform onto which respective rows of containers to be washed progressively form, the containers being fed to the platform in a known manner. Such rows are advanced towards the inlet station.

The sequencing device withdraws the containers from the respective rows and feeds them to the chain conveyor at a given rate.

The chain conveyor is fed with such respective rows of containers to be washed at the inlet station by the feeding system and outlets washed articles at the outlet station.

In detail, the chain conveyor comprises a plurality of beams, which are fed at the inlet station by the feeding system with respective rows of containers.

In greater detail, each beam comprises a plurality of aligned pockets organized in respective rows, each pocket being configured to receive one container to be treated at a time, to convey such container from the inlet station to the outlet station through the washing tunnel along the washing path and through all the treatment zones, and to deliver the respective washed container at the outlet station.

More precisely, each beam is discharged of the respective washed containers at the outlet station and then is returned along a return path to the inlet station, where it receives new empty containers to be washed.

According to the advancing direction of the containers along the washing path and inside the washing tunnel, the treatment zones comprise, in sequence: a prewash zone, at least first and second cleaning zones, and a plurality of consecutive rinsing zones.

The prewash zone, the first cleaning zone, and the second cleaning zone comprise respective cleaning baths, defined by respective tanks which are filled with washing chemical agents and through which the containers are advanced.

Each rinsing zone comprises several rinsing baths filled with rinsing liquid and/or ejecting devices for directing sprinkles of rinsing liquid toward the containers.

In general, the containers need to be treated through the cleaning zones for a relatively long time and at relatively high temperatures in order to be effectively deprived from the most encrusted dirt mounds, especially the ones heavily sedimented at the bottom of the containers themselves.

This can lead to high energy consumption or to a longer cleaning time.

The use of ultrasonic waves has been proposed, such as in WO-A-2020119958 in the name of the same Applicant, for aiding the cleaning process, in order to reduce energy consumption and/or cleaning time.

Briefly, the ultrasonic waves propagate in water and, more in general, in a medium with a relative periodic motion with respect to the medium itself, such that local micro-zones within the medium pass periodically from a depressurized to a pressurized state.

During the depressurized state, air dissolved within the medium tends to form many microbubbles, which implode when pressure increases so as to release energy.

Such energy may be useful to disaggregate the aforementioned encrusted dirt mounds, such that cleaning the containers results significantly eased, thus requiring less energy and/or less time.

Although being well-performing and functionally valid, the Applicant has observed that the washing machines, and the relative methods, are still open to further improvement, in particular as per energy consumption, better sizing of the washing machine, and better management of the so called “overspeed” operating condition.

More specifically, it is known in the field the need for an operation of the washing machine under the so-called “overspeed” conditions. More precisely, the filling machine is to be fed with a preset nominal rate of containers to fill. If, for a certain period of time, the filling machine is fed with a rate lesser than the nominal rate, then the washing machine has to compensate for the lesser rate by operating the chain conveyor at a higher speed, that is by operating at overspeed conditions.

However, higher speed of the chain conveyor causes less bathing time, which could cause an improper cleaning of the containers.

A proposed solution is to increase the temperature of the cleaning baths. However, the size of a typical washing machine is such that the transient time for reaching the new higher temperature is too large to compensate for the overspeed conditions, resulting in some containers being not properly washed.

### DISCLOSURE OF INVENTION

It is therefore an object of the present invention to provide a washing machine for washing containers and a relative method for treating containers, which are designed to overcome at least one of the above-mentioned drawbacks in a straightforward and low-cost manner.

This object is achieved by a washing machine, and a relative method, as claimed in the appended independent claims.

### BRIEF DESCRIPTION OF THE DRAWINGS

Non-limiting embodiments of the present invention will be described by way of example with reference to the accompanying drawings, in which:

FIG. 1 is a schematic lateral view, partially sectioned, and with parts removed for clarity of a washing machine according to the invention;

FIG. 2 is a schematic block diagram of a treatment assembly according to an embodiment of the present invention and comprising the washing machine of FIG. 1; and

FIG. 3 is a schematic block diagram of a treatment assembly according to an alternative embodiment of the present invention and comprising the washing machine of FIG. 1.

### BEST MODE FOR CARRYING OUT THE INVENTION

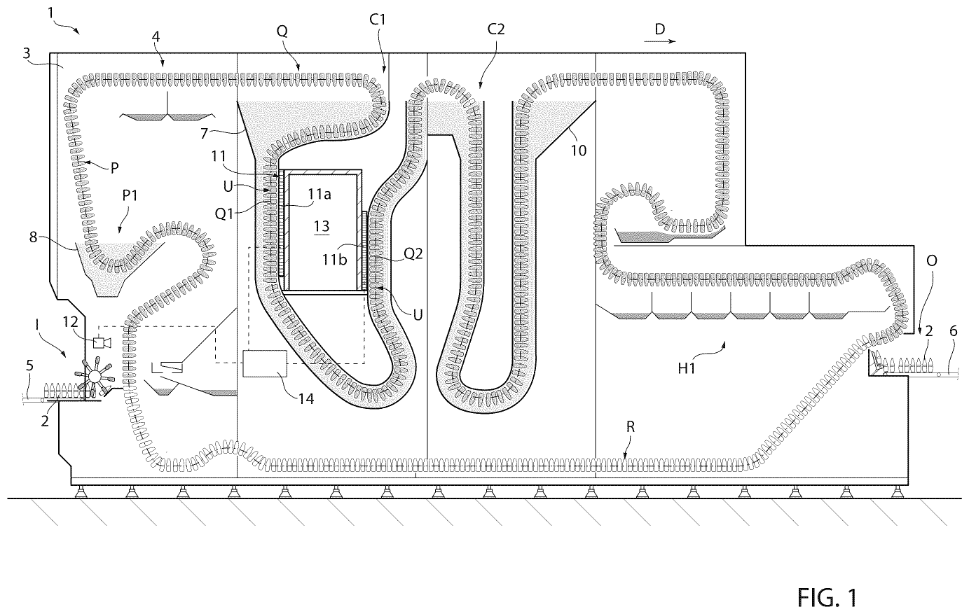

With reference to FIG. 1, number 1 indicates as a whole a washing machine for washing empty containers 2 adapted to be filled with a pourable product, preferably a pourable food product such as beer, wine, water, juice, soft drinks, milk or the like.

In particular, containers 2 are defined by respective empty bottles (for example, returnable glass bottles) intended to be filled with the pourable product.

According to one embodiment, washing machine 1 is part of a treatment assembly 100 for treating containers 2. For example, treatment assembly 100 can be defined by a packaging assembly for packaging the pourable product with containers 2, i.e. an assembly 100 for washing containers 2, for filling containers 2 by means of a filling machine 101, for labelling containers 2 and for capping containers 2.

Washing machine 1 comprises:
a washing tunnel 3 into which empty containers 2 are fed and accordingly washed; and
a conveyor device 4 including seats (not shown) for receiving respective containers 2 and configured to cyclically convey a plurality of containers 2 in their respective seats along a washing path P in an advancement direction.

Preferably, the conveyor device comprises a chain conveyor 4 for advancing containers 2 along a closed-loop washing path P inside washing tunnel 3, so as to convey containers 2 from one end of the tunnel 3 to the other end along a general direction D, preferably horizontal with respect to gravity.

In detail, chain conveyor 4 is of the type described in WO-A-2020119958 and comprises:
a pair of chains (not shown) elongated parallel to washing path P and parallel to one another; and
a plurality of consecutive conveying beams (known per se and not shown), which extend between the chains in a transversal and, more in detail, orthogonal manner to the chains and washing path P.

Specifically, each beam comprises a row of pockets (known per se and not shown) aligned orthogonally to washing path P and configured to receive corresponding containers 2.

In greater detail, the pockets of each beam define the above-mentioned seats.

In such a manner, containers 2 carried by a corresponding beam are aligned orthogonally to path P and housed inside the respective pockets, individually.

Washing machine 1 comprises also a feeding system 5 of the known type (only schematically shown in FIG. 1) for feeding a sequence of empty containers 2 along direction D and at an inlet station I of washing tunnel 3. Expediently, containers 2 are fed by feeding system 5 along direction D arranged in rows which are suitably orthogonal to path P.

In other words, feeding system 5 is configured for feeding respective rows of containers 2, each formed by a respective plurality of empty containers, to conveyor 4 at inlet station I.

In use, and sequentially, the most forward containers 2 of each row of containers 2 are transferred by feeding system 5 to the respective pockets of the beam that is travelling at inlet station I.

In practice, each beam is configured to receive, at inlet station I, one respective row of containers 2.

Washing machine 1 further comprises an outfeed conveyor 6, which receives rows of cleaned and washed containers 2 from chain conveyor 4 at an outlet station O of washing tunnel 3.

Hence, conveyor 4 is configured to convey the containers 2, by means of the beams and their pockets, from inlet station I to outlet station O.

In light of the above, washing path P comprises:
a washing branch Q, which extends from inlet station I to outlet station O and along which containers 2 are advanced by chain conveyor 4; and
a return branch R, which extends from outlet station O to inlet station I and defines a return zone through which the beams return towards inlet station I after having discharged containers 2, i.e. with their respective pockets emptied.

According to the aforementioned advancing direction of the containers 2 along path P, washing machine 1 comprises in sequence along washing branch Q a plurality of treatment stations or zones, namely:
a prewash zone P1;
a first cleaning zone C1;
preferably, a second cleaning zone C2; and
a final rinsing zone H1.

In the present disclosure, for the sake of clarity, terms like “upstream of” and “downstream of” are to be intended throughout the whole description and claims with reference to the advancing direction of containers 2 along path P.

The operation of washing machine 1 at the prewash zone P1, second cleaning zone C2 and final rinsing zone H1 is well-known, for example from WO-A-2020119958, and therefore will not be described in detail herein.

Reference will be made in the following to first cleaning zone C1.

First cleaning zone C1 comprises a respective tank 7 for holding a corresponding cleaning medium or agent for washing containers 2.

In detail, tank 7 is filled with a cleaning agent which, in use, is brought to a temperature higher than that within the prewash zone P1, for instance between 65° C. and 80° C., so that dirt on containers 2 advancing therein is fully removed.

In greater detail, path P, and particularly a portion of washing branch Q, extends through and along tank 7.

Hence, tank 7 defines a cleaning (hot) bath of washing machine 1 for cleaning washing the containers 2.

Preferably, the prewash zone P1 and the second cleaning zone C2 comprise respective tanks 8, 10 which are filled with cleaning agents at different respective temperatures (according to a manner known and not described herein), thus defining defining respective further cleaning baths (and treating stations) of washing machine 1.

Conveniently, the cleaning agents filling the respective tanks 7, 8, 10 comprise corresponding basic aqueous solutions that include, in particular, sodium hydroxide.

First cleaning zone C1 further includes at least one ultrasonic wave generator 11 arranged adjacent to path P for defining an ultrasonic treatment sector U thereof.

In detail, generator 11 is coupled to tank 7 and is configured to propagate ultrasonic waves through the cleaning medium such that containers 2 receive an ultrasonic cleaning treatment during their advancement through tank 7 and along ultrasonic treatment sector U.

In greater detail, generator 11 is of the type described in WO-A-2020119958 and comprises a plurality of ultrasonic transducers or emitters (already known in the field), which are conveniently plate-shaped, are configured to convert electric power into ultrasounds, and are sequentially arranged adjacent and parallel to one another along path P.

Preferably, washing machine 1 includes an electric power generator (not shown) for supplying generator 11 with electric energy.

Preferably, generator 11 includes:
a first generator member 11a arranged adjacent to tank 7 and defining a first stretch of ultrasonic treatment sector U; and
a second generator member 11b arranged adjacent to tank 7 and operatively downstream of first generator member 11a.

According to the preferred and non-limiting embodiment shown, washing machine 1 comprises a hollow passage 1 which extends through tank 7 and which is fluidly isolated from tank 7.

In particular, path P, and particularly washing branch Q, has, within tank 7, an inlet sector Q1 for advancing containers 2 in tank 7 and an outlet sector Q2 for advancing containers 2 out from tank 7.

Conveniently, hollow passage 13 extends through tank 7 in such a way to be interposed between inlet sector Q1 and outlet sector Q2.

Expediently, hollow passage 13 defines a tunnel (e.g. an inspection and/or £ maintenance tunnel) accessible by a maintenance operator from the outside of washing machine 1.

More specifically, hollow passage 13 has a size such that the operator, i.e. a normal-sized person, can fit and perform inspection and/or maintenance operation therein.

Thanks to the presence of hollow passage 13, inspection and/or maintenance of the components located at tank 7 and in the vicinity of tank 7 is facilitated and improved.

According to the preferred embodiment shown, hollow passage 13 is blind, i.e. its entrance corresponds with its exit.

Consequently, the inspection and/or maintenance tunnel defined by hollow passage 13 is a blind tunnel or blind hole, and not a through tunnel or through hole.

Alternatively, hollow passage 13 is defined by a through hole, i.e. it extends through tank 7 from side to side.

Conveniently, first generator member 11a is arranged along inlet sector Q1 and second generator member 11b is arranged along outlet sector Q2.

The Applicant has observed that such configuration results in an improved cleaning effect on containers 2.

According to an aspect of the present invention, washing machine 1 comprises:
a sensor unit 12 configured to sequentially inspect each seat (i.e. each pocket of each beam) for detecting the presence of containers 2 therein downstream of the inlet station I, and to generate signals correlated to the absence of containers 2 in the inspected seats, i.e. when a seat is devoid of any container 2; and
a control unit 14 configured to receive said signals and to control generator 11 based on the received signals for modulating a level of ultrasonic wave generation when the inspected seats are conveyed along ultrasonic treatment sector U or when a preset number of seats operatively downstream of the inspected seats are conveyed along ultrasonic treatment sector U.

It is specified that with the previous sentence “preset number of seats operatively downstream of the inspected seats” are intended the seats successive with respect to the inspected seats, namely the seats of the beams which pass through sensor unit 1 after the inspected seats, for example seats that, when the aforementioned inspected seats are inspected by sensor unit 12, are located along return branch R.

In detail, according to an aspect of the invention, sensor unit 12 is configured to sequentially inspect each beam for detecting the presence of containers 2 on each beam and to generate first signals correlated to the inspected beams being fully empty, i.e. correlated to all the pockets/seats of the beam being devoid of containers 2.

Accordingly, control unit 14 is configured to receive said first signals and to control a deactivation of generator 11 based on said first signals and when the detected fully empty beams are conveyed along ultrasonic treatment sector U.

Expediently, control unit 14 is implemented with the advancement speed of conveyor 4 (i.e. knows at all time during operation the advancement speed of conveyor 4), so that control unit 14 is able to track the position of each beam along washing path P.

Hence, control unit 14 is configured to deactivate generator 11 precisely when the detected fully empty beams are conveyed along ultrasonic treatment sector U.

In this way, generator 11 is deactivated when beams fully devoid of containers 2 transit along ultrasonic treatment sector U, thereby resulting in electric energy savings and reduced production and environmental costs.

Advantageously, the ultrasonic emitters are distributed along a portion of path P and are selectively activatable independently from one another so as to define ultrasonic treatment sector U.

According to a further aspect of the present invention, sensor unit 12 is configured to sequentially inspect each beam for detecting, for each beam, a percentage of full seats (or pockets), i.e. seats occupied with a container 2, over empty seats, and to generate second signals correlated to the detected percentages.

Accordingly, control unit 14 is configured to receive the second signals and to control generator 11 based on the second signals for increasing the aforementioned level of ultrasonic wave generation when the detected percentage is below a preset threshold value for a predetermined number of preferably consecutive inspected beams.

It is specified that the aforementioned number of inspected beams could also not be defined by consecutive beams, i.e. by beams adjacent to one another. In other words, the number of inspected beams could comprise beams which are not immediately adjacent to one another but also beams relatively close to one another, relative to path P, without being adjacent. For example, the predetermined number of inspected beams can comprise a group of beams close to one another but not necessarily adjacent, thereby defining a region of grouped beams for which the seats are not fully occupied with containers 2, and for which the detected percentage is below the preset threshold value.

More in particular, control unit 14 is configured to control generator 11 based on the second signals for increasing the number of activated ultrasonic emitters when the detected percentage is below said preset threshold value for said predetermined number of consecutive inspected beams.

Even more in particular, control unit 14 is configured to increase the number of activated ultrasonic emitters when the detected percentage is below said preset threshold value for said predetermined number of consecutive inspected beams and when a preset number of beams operatively downstream of said consecutive inspected beams is conveyed along said ultrasonic treatment sector, thereby increasing said level of ultrasonic wave generation for the containers 2 carried on such preset number of beams.

Due to the fact that the ultrasonic emitters are distributed along path P, and according to the invention, control unit 14 is configured to control generator 11 based on the second signals for increasing the extension, along washing path P, of said ultrasonic treatment sector U when the detected percentage is below said preset threshold value for the predetermined number of consecutive inspected beams, thereby modulating said level of ultrasonic wave generation.

Thanks to the above configuration, the management of the aforementioned overspeed operating condition is largely improved.

More precisely, when a certain number of beams are filled with containers 2 at a percentage below said predetermined threshold value, filling machine 101 will be fed with a rate of containers 2 to fill which is lesser than the nominal rate. Hence, washing machine 1 will have to operate at said overspeed condition, in order to compensate for the less than nominal rate.

Thanks to the configuration according to the invention, the modulation, and particularly the increase, of said ultrasonic wave generation compensate for the aforementioned less bathing time during the overspeed condition, thereby allowing a proper washing of containers 2 without the need for increasing the temperature of the cleaning bath.

Advantageously, sensor unit 12 is arranged downstream of inlet station I and upstream of prewash zone P1, with respect to washing path P.

The Applicant has observed that such positioning of sensor unit 12 is the optimal one with respect to washing path P.

Alternatively, sensor unit 12 could be arranged at a loading moving platform of feeding system 5, known per se and not described in detail.

According to the preferred embodiment, sensor unit 12 includes:
at least one first sensor (not shown) configured to detect the presence of a first container 2 in each beam; and
at least one second sensor or sensor group (not shown) configured to detect the presence of other containers 2 in each beam.

In one embodiment, control unit 14 is configured to control generator 11 for modulating the ultrasonic wave generation by increasing the power, i.e. the electric power, supplied to the generator 11 itself.

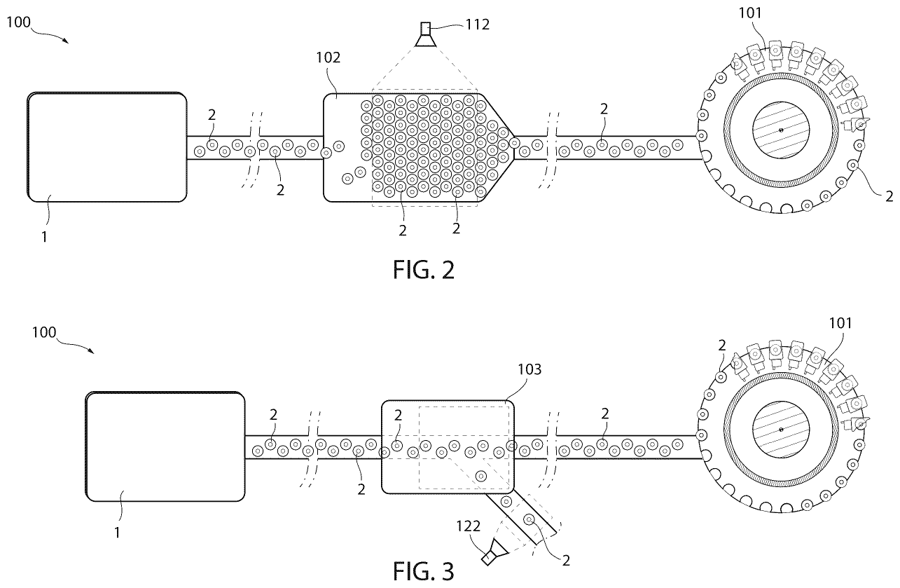

According to a first preferred embodiment shown in FIG. 2, treatment assembly 100 comprises:
washing machine 1;
a filling machine 101 arranged operatively downstream of washing machine 1; and
a buffer device 102 operatively interposed between washing machine 1 and filling machine 101 and configured to temporarily store a number of washed containers 2 to be filled.

According to an aspect of the present invention, treatment assembly 100 comprises a further sensor unit 112 located at buffer device 102 and configured to detect a storing percentage of containers 2 in the buffer device 102 itself, i.e. a level of fullness of buffer device 102.

Accordingly, control unit 14 is further configured to control generator 11 for increasing said level of ultrasonic wave generation when, and while, the detected storing percentage is below a preset threshold value.

Thanks to the aforementioned configuration, the management of the overspeed condition is further improved.

More in particular, if the storing percentage of buffer device 102 is below the preset threshold value, filling machine 101 will receive less containers 2 for a given period of time, i.e. the rate will be less than the nominal rate. Consequently, washing machine 1 will have to operate at said overspeed condition, in order to compensate for the less than nominal rate.

Thanks to the configuration according to the invention, the modulation, and particularly the increase, of said ultrasonic wave generation compensate for the aforementioned less bathing time during the overspeed condition, thereby allowing a proper washing of containers 2 without the need for increasing the temperature of the cleaning bath.

According to a second preferred embodiment shown in FIG. 3, treatment assembly 100 comprises an inspector device 103 operatively interposed between washing machine 1 and filling machine 101 and configured to inspect the washed containers 2 upstream of filling machine 101 and to discard containers 2 based on said inspection.

According to an aspect of the present invention, treatment assembly 100 comprises a further sensor unit 122 located at inspector device 103 and configured to detect a discarding percentage of containers 2 discarded by inspector device 103, i.e. to detect a percentage of containers 2 discarded by inspector device 103 over total containers 2 fed to filling machine 101.

Accordingly, control unit 14 is further configured to control generator 11 for increasing said level of ultrasonic wave generation when the detected discarding percentage is above a preset threshold value.

Thanks to the aforementioned configuration, the management of the overspeed condition is further improved.

More in particular, if the discarding percentage of buffer device 103 is above the preset threshold value, filling machine 101 will receive less containers 2 for a given period of time, i.e. the rate will be less than the nominal rate. Consequently, washing machine 1 will have to operate at said overspeed condition, in order to compensate for the less than nominal rate.

Thanks to the configuration according to the invention, the modulation, and particularly the increase, of said ultrasonic wave generation compensate for the aforementioned less bathing time during the overspeed condition, thereby allowing a proper washing of containers 2 without the need for increasing the temperature of the cleaning bath.

The operation of washing machine 1 is briefly described in the following.

Feeding system 5 advances a plurality of rows of containers 2 to be washed towards washing tunnel 3 in a manner parallel to direction D.

The properly positioned containers 2 are arranged with their respective longitudinal axes orthogonal to path P.

The beams of chain conveyor 4 withdraw (or are fed with) respective rows of containers 2 at inlet station I, advance containers 2 inside washing tunnel 3 along the washing branch Q, discharge rows of cleaned containers 2 at outlet station o onto out feed conveyor 6, and return along return branch R devoid from containers 2.

In detail, containers 2 of each row are first carried by the respective pockets through prewash zone P1, then through first cleaning zone C1, then through second cleaning zone C2 and then through rinsing zone H1.

During operation, control unit 14 controls generator 11 for modulating ultrasonic wave generation based on first signals and/or second signals, and/or as a function of the detection of sensor unit 112 and/or sensor unit 122.

From the foregoing, it is clear how washing machine 1 and treatment assembly 100 allow to implement a method for treating empty containers adapted to be filled with a pourable product, the method comprising the steps of:
a) feeding a plurality of empty containers to be washed into respective seats;
b) cyclically advancing the seats along a washing path from an inlet station, at which the containers to be washed are fed into the seats, to an outlet station, at which the washed containers exit from the respective seats;
c) conveying the seats through a cleaning medium for washing the containers;
d) actuating an ultrasonic wave generator for propagating ultrasonic waves through said cleaning medium;
e) conveying the seats through an ultrasonic treatment sector of the washing path for exposing the containers to the ultrasonic waves;
f) sequentially inspecting each seat for detecting the presence of containers therein downstream of the inlet station;
g) generating signals correlated to the absence of containers in the inspected seats; and
h) controlling the ultrasonic wave generator based on said signals for modulating a level of ultrasonic wave generation when the inspected seats are conveyed along said ultrasonic treatment sector or when a preset number of seats operatively downstream of the inspected seats are conveyed along said ultrasonic treatment sector.

The advantages of washing machine 1, and of the relative method for treating empty containers 2, according to the present invention will be clear from the foregoing description.

In particular, thanks to the above configuration, the management of the aforementioned overspeed operating condition is largely improved.

More precisely, when a certain number of beams are filled with containers 2 at a percentage below said predetermined threshold value, filling machine 101 will be fed with a rate of containers 2 to fill which is lesser than the nominal rate. Hence, washing machine 1 will have to operate at said overspeed condition, in order to compensate for the less than nominal rate.

Thanks to the configuration according to the invention, the modulation, and particularly the increase, of said ultrasonic wave generation compensate for the aforementioned less bathing time during the overspeed condition, thereby allowing a proper washing of containers 2 without the need for increasing the temperature of the cleaning bath.

Moreover, the need for an oversizing of washing machine 1 is eliminated, since the overspeed condition can be easily compensated by the efficient controlling and modulation of the ultrasonic wave generation, without the need for a larger tank 7.

Accordingly, washing machine 1 can be less cumbersome, thereby allowing for more usable space within treatment assembly 100.

Clearly, changes may be made to washing machine 1, and the relative method, as described herein without, however, departing from the scope of protection as defined in the accompanying claims.

1. A washing machine for washing empty containers adapted to be filled with a pourable product, the washing machine comprising:
a conveyor comprising respective seats for receiving respective containers and configured to cyclically convey a plurality of containers in the respective seats along a washing path extending from an inlet station to an outlet station,
wherein during use each seat is fed at the inlet station with a respective container to be washed, and
wherein during use the conveyor outlets washed containers to the outlet station; and
at least one treatment station comprising:
at least one tank configured to hold a cleaning medium for washing the containers, the washing path extending through the tank, and
at least one ultrasonic wave generator arranged adjacent to the washing path that defines an ultrasonic treatment sector thereof, and wherein the ultrasonic wave generator is configured to propagate ultrasonic waves through said cleaning medium such that said containers receive an ultrasonic cleaning treatment during their advancement through said tank and along said ultrasonic treatment sector;
wherein the washing machine further comprises:
a sensor unit configured to sequentially inspect each of the respective seats to detect the presence of containers therein downstream of the inlet station, and to generate signals correlated to the absence of containers in the inspected seats; and
a control unit configured to receive said signals and to control the ultrasonic wave generator based on the received signals for modulating a level of ultrasonic wave generation when the inspected seats are conveyed along said ultrasonic treatment sector or when a preset number of seats operatively downstream of the inspected seats are conveyed along said ultrasonic treatment sector.

2. The washing machine as claimed in claim 1, further comprising a feeding system configured to feed respective rows of containers to the conveyor at said inlet station, wherein each respective row is formed by a respective plurality of empty containers;
wherein the conveyor comprises a plurality of consecutive beams each having a plurality of said seats, each beam being configured to receive, at the inlet station, one respective row of containers; and
wherein:
the sensor unit is configured to sequentially inspect each beam to detect the presence of containers thereon and to generate first signals correlated to the inspected beams being fully empty;
the control unit is configured to receive said first signals and to control a deactivation of the ultrasonic wave generator based on said first signals and when the detected fully empty beams are conveyed along said ultrasonic treatment sector.

3. The washing machine as claimed in claim 1, further comprising:
a feeding system for feeding respective rows of containers, each formed by a respective plurality of empty containers, to the conveyor at said inlet station;
wherein the conveyor comprises a plurality of consecutive beams each having a plurality of said seats, each beam being configured to receive, at the inlet station, one respective row of containers; and
wherein:
the sensor unit is configured to sequentially inspect each beam to detect, for each beam, a percentage of full seats over empty seats, and to generate second signals correlated to the detected percentages;
the control unit is configured to receive said second signals and to control said ultrasonic wave generator based on said second signals to increase said level of ultrasonic wave generation when the detected percentage is below a preset threshold value for a predetermined number of inspected beams.

4. The washing machine as claimed in claim 3, wherein the ultrasonic wave generator includes a plurality of ultrasonic emitters distributed along a portion of the washing path, wherein each of the plurality of ultrasonic emitters are selectively activatable independently from one another so as to define said ultrasonic treatment sector;
and wherein the control unit is configured to control the ultrasonic wave generator based on said second signals for increasing a number of activated ultrasonic emitters when the detected percentage is below said preset threshold value for the predetermined number of inspected beams.

5. The washing machine as claimed in claim 4, wherein the control unit is configured to increase the number of activated ultrasonic emitters when the detected percentage is below said preset threshold value for the predetermined number of inspected beams and when a preset number of beams operatively downstream of said inspected beams is conveyed along said ultrasonic treatment sector, thereby increasing said level of ultrasonic wave generation for the containers carried on such preset number of beams.

6. The washing machine as claimed in claim 4, wherein the control unit is configured to control the ultrasonic wave generator based on said second signals to increase the extension along the washing path of said ultrasonic treatment sector when the detected percentage is below said preset threshold value for the predetermined number of inspected beams, thereby modulating said level of ultrasonic wave generation.

7. The washing machine as claimed in claim 1, comprising a prewash station including a tank configured to hold a cleaning medium for prewashing the containers, wherein the prewash station is arranged upstream of the treatment station with respect to the washing path;
and wherein the sensor unit is arranged downstream of the inlet station and upstream of the prewash station with respect to the washing path.

8. A treatment assembly for treating containers adapted to be filled with a pourable product, the assembly comprising:
a washing machine as claimed in claim 1;
a filling machine arranged operatively downstream of the washing machine, the filling machine configured to fill the washed containers with the pourable product; and
a buffer device operatively interposed between the washing machine and the filling machine and configured to temporarily store a number of washed containers to be filled;
wherein the treatment assembly comprises a further sensor unit located at said buffer device and configured to detect a storing percentage of containers in the buffer device
and wherein the control unit is further configured to control the ultrasonic wave generator for increasing said level of ultrasonic wave generation when, and while, the detected storing percentage is below a preset threshold value.

9. A treatment assembly for treating containers adapted to be filled with a pourable product, the assembly comprising:
a washing machine as claimed in claim 1;
a filling machine arranged operatively downstream of the washing machine, the filling machine configured to fill the washed containers with the pourable product; and
an inspector device operatively interposed between the washing machine and the filling machine and configured to inspect the washed containers upstream of the filling machine and to discard containers based on said inspection;
wherein the treatment assembly comprises a further sensor unit located at said inspector device and configured to detect a discarding percentage of containers discarded by the inspector device;
and wherein the control unit is further configured to control the ultrasonic wave generator for increasing said level of ultrasonic wave generation when the detected discarding percentage is above a preset threshold value.

10. A method for treating empty containers adapted to be filled with a pourable product, the method comprising the steps of:
a) feeding a plurality of empty containers to be washed into respective seats;
b) cyclically advancing the respective seats along a washing path from an inlet station to an outlet station,
wherein the inlet station, the containers to be washed are fed into the respective seats, and
wherein at the outlet station, the washed containers exit from the respective seats;
c) conveying the seats through a cleaning medium for washing the containers;
d) actuating an ultrasonic wave generator for propagating ultrasonic waves through said cleaning medium;
e) conveying the seats through an ultrasonic treatment sector of the washing path, wherein the ultrasonic treatment sector is configured to expose the containers to the ultrasonic waves;
f) sequentially inspecting each seat to detect the presence of containers therein downstream of the inlet station;
g) generating signals correlated to the absence of containers in the inspected seats; and
h) controlling the ultrasonic wave generator based on said signals to modulate a level of ultrasonic wave generation when the inspected seats are conveyed along said ultrasonic treatment sector or when a preset number of seats operatively downstream of the inspected seats are conveyed along said ultrasonic treatment sector.

11. The method as claimed in claim 10, wherein the step a) of feeding comprises feeding respective rows of containers, each formed by a respective plurality of empty containers, to a plurality of consecutive beams each having a plurality of said seats and being configured to receive one said row at a time;
wherein the step f) of inspecting comprises sequentially inspecting each beam to detect the presence of containers thereon;
wherein the step g) of generating comprises generating first signals correlated to the inspected beams being fully empty;
and wherein the step h) of controlling comprises controlling a deactivation of the ultrasonic wave generator based on said first signals and when the detected fully empty beams are conveyed along said ultrasonic treatment sector.

12. The method as claimed in claim 10, wherein the step a) of feeding comprises feeding respective rows of containers, each formed by a respective plurality of empty containers, to a plurality of consecutive beams each having a plurality of said seats and being configured to receive one said row at a time;
wherein the step f) of inspecting comprises sequentially inspecting each beam to detect, for each beam, a percentage of full seats over empty seats;
wherein the step g) of generating comprises generating second signals correlated to the detected percentages;
and wherein the step h) of controlling comprises controlling the ultrasonic wave generator based on the second signals to increase said level of ultrasonic wave generation when the detected percentage is below a preset threshold value for a predetermined number of inspected beams.

13. The method as claimed in claim 12, wherein the step d) of actuating comprises activating ultrasonic emitters;
and wherein the step h) of controlling comprises increasing a number of activated ultrasonic emitters when the detected percentage is below said preset threshold value for the predetermined number of inspected beams.

14. The method as claimed in claim 13, wherein the step h) of controlling further comprises increasing the number of activated ultrasonic emitters when a preset number of beams operatively downstream of said inspected beams is conveyed along said ultrasonic treatment sector, thereby increasing said level of ultrasonic wave generation for the containers carried on such preset number of beams.

15. The method as claimed in claim 10, further comprising the steps of:
filling the containers with the pourable product after washing the containers;
j) temporarily storing the washed containers via a buffer device in a position operatively downstream of the outlet station and prior to, and operatively upstream of, the step i) of filling;
k) detecting a storing percentage of containers in the buffer device;
and wherein the step h) of controlling further comprises controlling the ultrasonic wave generator to increase said level of ultrasonic wave generation when, and while, the detected storing percentage is below a preset threshold value.

16. The method as claimed in claim 10, further comprising the steps of:
i) filling the containers with the pourable product after washing thereof;
l) inspecting the washed containers via an inspector device in a position operatively downstream of the outlet station and prior to, and upstream of, the step i) of filling;
m) discarding containers based on the step l) of inspecting;
n) detecting a discarding percentage of containers discarded by the inspector device;
and wherein the step h) of controlling further comprises controlling the ultrasonic wave generator for increasing said level of ultrasonic wave generation when the detected discarding percentage is above a preset threshold value.
